(19) United States
(12) Patent Application Publication
(10) Pub. No.: US 2006/0210283 A1
(43) Pub. Date: Sep. 21, 2006

(54) TRANSMITTERS FOR INVERSELY DISPERSED OPTICAL SIGNALS

(75) Inventor: Masataka Shirasaki, Mountain View, CA (US)

Correspondence Address: AKA CHAN LLP, 900 LAFAYETTE STREET, SUITE 710, SANTA CLARA, CA, 95050, US

(73) Assignee: ARASOR CORPORATION, Mountain View, CA (US)

(21) Appl. No.: 11/162,683

(22) Filed: Sep. 19, 2005

Related U.S. Application Data
(60) Provisional application No. 60/611,484, filed on Sep. 20, 2004.

(51) Int. Cl. H04B 10/04; H04B 10/12

(52) U.S. Cl. 398/188

(57) ABSTRACT

Transmitters for generating inversely dispersed optical signals to counter chromatic dispersion in optical fibers carrying the optical signals are presented. The transmitters have optical pulse generators which generate in parallel inversely dispersed optical pulses which are combined for output into an optical fiber. Different designs with simple modulators can be used for the optical pulse generator

### CROSS REFERENCES TO RELATED APPLICATIONS

This application claims priority to U.S. Provisional Patent Application No. 60/611,484, entitled “TIME DIVISION MULTIPLEXING FOR INVERSELY DISPERSED PULSES” and filed Sep. 20, 2004, which provisional patent application is hereby incorporated by reference herein.

### BACKGROUND OF THE INVENTION

The present invention is related to optical signal transmitters and, more particularly, to transmitters which generate optical signals which counter chromatic dispersion in the optical fibers carrying the signals.

Optical transmitters typically receive digital electrical signals and generate corresponding optical signals for transmission onto an optical fiber. The transmitter modulates light so that the optical signals appear as a sequence of optical pulses, representing a sequence of bits, traveling through the optical fiber. However, chromatic dispersion in the optical fiber forces the wavelength components of an optical signal pulse to travel at slightly different velocities down the fiber. After some distance, the shape of the optical signal pulses is distorted and renders it difficult to determine the information of the optical signals, especially for signals being transmitted at high bit rates. The receiver of the deteriorated optical signals is unable to determine whether a pulse corresponds to a “1” or “0” bit.

To counter the chromatic dispersion, it is possible to inversely disperse the optical signal pulses at the transmitter and then send them onto the optical fiber. Then the pulses become non-dispersed pulses at the receiver. The inversely dispersed signals can theoretically be generated by carefully controlling the amplitude and the phase of the light. However, this technique requires complicated electrical control circuits. Dispersion compensator devices can also be used to generate the inversely dispersed signals optically. Well known dispersion compensators include dispersion compensation fibers, chirped fiber Bragg gratings, and optical interferometers. However, dispersion compensation fibers are costly and occupy a large volume. Chirped fiber Bragg gratings and optical interferometers have limited wavelength bandwidths for a given amount of dispersion.

Thus there is a need for a simple, effective and economical optical transmitter which can generate signals which retain their information even after transmission over long distances through optical fibers with chromatic dispersion. The present invention provides for a simple design of an optical transmitter which generates an equivalent of the inversely dispersed optical signal waveforms to counter virtually unlimited amounts of dispersion without the use of complicated electrical or optical circuits.

### SUMMARY OF THE INVENTION

The present invention provides for an optical transmitter generating optical signals for an optical fiber transmission corresponding to electrical signals received at a first signal rate. The optical transmitter has a plurality of optical pulse generators generating in parallel inversely dispersed optical pulses corresponding to the received electrical signals at the first signal rate; and a coupler assembly combining the generated inversely dispersed optical pulses for transmission in the optical fiber. The combination of inversely dispersed optical pulses counter chromatic dispersion in the optical fiber because optical pulses independently arrive at a receiver as non-dispersed optical pulses corresponding to the received electrical signals at the first signal rate. Furthermore, each optical pulse generator is responsive to one of N subsets of the received electrical signals, each electrical signal of a subset separated by N−1 electrical signals of other subsets. Each optical pulse generator generates a subset of inversely dispersed optical signal pulses at 1/N of said first signal rate. The coupler assembly couples an output of each of the optical pulse generators and sends them to the optical fiber so that the inversely dispersed optical pulses of each subset travel independently in the optical fiber. Each generated inversely dispersed optical pulse has a duration no more than that of N received signal pulses at the first signal rate.

The present invention also provides for a method of operating an optical transmitter to generate optical signals in an optical fiber. The method has the steps of receiving electrical signals at a first signal rate; generating in parallel inversely dispersed optical pulses corresponding to the received electrical signals at the first signal rate; and combining the plurality of inversely dispersed optical pulses for transmission in the optical fiber. The combination of inversely dispersed optical pulses counter chromatic dispersion in the optical fiber because the optical pulses independently arrive at a receiver as non-dispersed optical pulses corresponding to the received electrical signals at the first signal rate. The inversely dispersed optical pulses are generated as N subsets of inversely dispersed optical pulses at a signal rate 1/N of the first signal rate with each subset corresponding to one of N subsets of the received electrical signals, and the N subsets of inversely dispersed optical pulses are combined so that inversely dispersed optical pulses of each subset are separated by N−1 inversely dispersed optical pulses of other subsets.

### BRIEF DESCRIPTION OF THE DRAWINGS

A better understanding of the present invention may be attained by a perusal of the following drawings and following textual description. Furthermore, it should be understood that in many drawings, the same reference numerals are used where elements are the same or have very similar functions.

FIG. 1 illustrates the effects of chromatic dispersion on a sequence of inversely dispersed pulses formed at a transmitter, and after traveling in an optical fiber with chromatic dispersion to a receiver;

FIG. 2 shows an optical transmitter with two optical pulse generators, according to one embodiment of the present invention;

FIGS. 3A-3C show optical transmitter designs with different optical pulse generator designs according to the present invention;

FIG. 4 shows an optical transmitter with four optical pulse generators, according to one embodiment of the present invention;

FIG. 5A illustrates inversely dispersed optical pulses which are orthogonally polarized, at an optical transmitter output and at the receiver after travel through an optical fiber with chromatic dispersion, according to an embodiment of the present invention; FIG. 5B shows an optical transmitter with two waveguide modulators which generates orthogonally polarized pulses illustrated in FIG. 5A in accordance to the present invention;

FIGS. 6A-6C illustrate numerically calculated shapes of an inversely dispersed pulse along a transmission fiber with initial pulse durations in a time spans of two bits, four bits, and eight bits, respectively, for transmissions over increasing distances, according to the present invention; and

FIG. 7 shows a confirmatory empirical eye pattern at 10 Gbit/s after the transmission of a 100 km long standard single mode fiber at 1.55 μm wavelength, which has chromatic dispersion of 1700 ps/nm.

### DESCRIPTION OF SPECIFIC EMBODIMENTS

When an isolated optical signal pulse with a uniform phase travels through a fiber which has chromatic dispersion, the pulse is broadened. When an inversely dispersed pulse, which is a pulse stretched by a dispersion compensator for example, travels through the transmission fiber, the pulse is compressed and a non-dispersed pulse is detected at the receiver, assuming there are no optical nonlinear effects in the fiber. The inversely dispersed pulse is a stretched pulse with an approximately parabolic phase, where the pulse duration is determined by the amount of the chromatic dispersion. In other words, the larger the dispersion, the longer the pulse duration. Regardless of the amount of dispersion, a correctly generated inversely dispersed pulse arrives at the receiver as a non-dispersed pulse that has the duration of about one bit. This is due to the compression of a chirped pulse with chromatic dispersion in the fiber. Of course, since the amount of chromatic dispersion is dependent upon the distance of travel along the optical fiber, the duration of the inversely dispersed pulse, which is to be transmitted, is determined by the distance between the receiver and the transmitter.

An inversely dispersed pulse can be produced directly by an optical pulse generator. There are simple designs of optical pulse generators, which produce an inversely dispersed pulse without using a dispersion compensator. One design uses a CW (continuous wave) light source, an intensity modulator, and a phase modulator in series. The intensity modulator shapes the CW light from a CW light source into a stretched pulse and the phase modulator gives the parabolic phase to it. A well known CW light source is a diode laser. Thus, an inversely dispersed pulse is produced. The intensity modulator and the phase modulator may be combined into one device, such as a conventional intensity modulator with frequency chirping. Another design to produce an inversely dispersed pulse uses a frequency chirping light source and an intensity modulator. The frequency of light can be chirped by directly modulating a diode laser, and thus light with a parabolic phase is produced. Then this light is shaped into a stretched pulse by the intensity modulator. This design is suitable when the chromatic dispersion is large, because the maximum optical phase in the pulse duration can be made large.

As explained previously, when inversely dispersed pulses are transmitted, the pulses arrive at the receiver as non-dispersed pulses. In the transmission of an isolated pulse, the inversely dispersed pulse can be produced as described above. However, in a train of data signals, there are more than one pulse and the non-dispersed pulses should arrive at the receiver with a time difference as short as a time span of one bit, as shown by the lower portion of FIG. 1. To achieve this, the transmitter must send out the inversely dispersed pulses with a time difference of a time span of one bit, as shown by the upper portion of FIG. 1. Although the non-dispersed pulses do not overlap at the receiver, the inversely dispersed pulses which are supposed to be transmitted, do overlap and interfere with each other at the transmitter, because the duration of an inversely dispersed pulse can be much longer than the time span of one bit. Each inversely dispersed pulse has a parabolic phase, and therefore, the interference makes the inversely dispersed waveform complicated. This complicated waveform can be produced in principle by calculating the waveform using electronic processors and modulating intensity and phase of light. But this calculation is complicated and it is impractical to build such a fast and complicated processors. There is no easy way to directly generate such a complicated waveform using a conventional optical or electronic device.

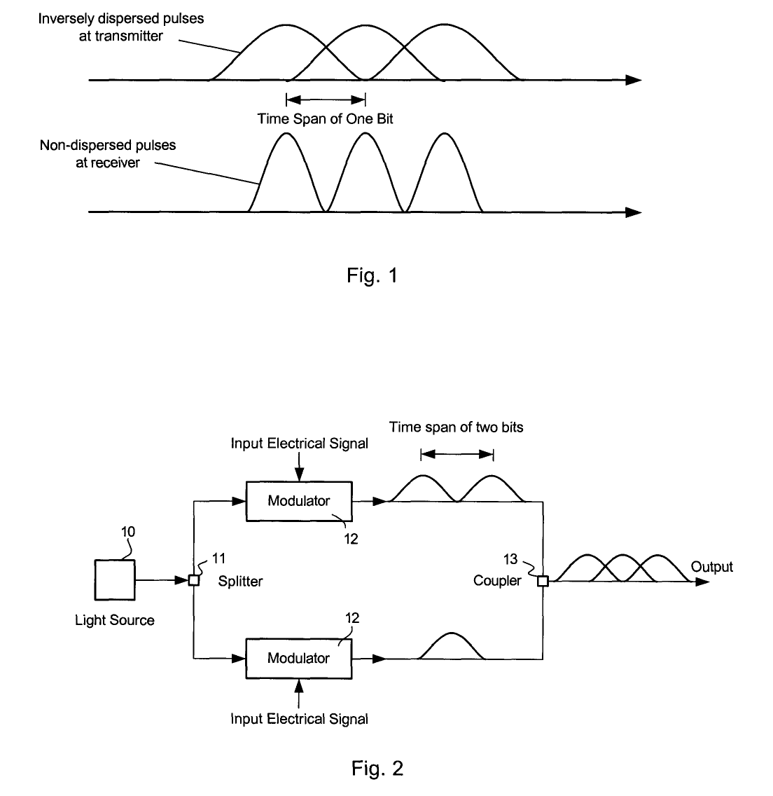

An equivalent of this complicated waveform can be generated through the interference of inversely dispersed pulses which are produced in parallel by a plurality of optical pulse generators. In accordance with one embodiment of the present invention, a transmitter design using two optical pulse generators is shown in FIG. 2. Light from a light source 10 such as a diode laser is split into two light paths by splitter 111 and modulators 12 in each light path produces inversely dispersed pulses. An optical coupler 13 combines the inversely dispersed pulses produced in the two light paths and sends the combined light to the transmitter output. The input electrical signals to the modulators 12 are adjusted to time the pulse production in the two light paths so that the inversely dispersed pulses from the two light paths arrive alternately at the coupler 13. Each modulator 12 has a time span of two bits to produce an inversely dispersed pulse. Therefore, all inversely dispersed pulses are isolated in each light path as long as the duration of the inversely dispersed pulse is within a time span of two bits, and the optical pulse generator designs described previously can be used as each optical pulse generator.

The combination of inversely dispersed optical pulses counter chromatic dispersion in the optical fiber because the optical pulses independently arrive at the receiver as non-dispersed optical pulses corresponding to the received electrical signals as long as no optical nonlinear effects are involved and the optical system is linear, or the nonlinear effects are small and can be effectively ignored.

It should be noted that the optical phases from two light paths do not need to be locked, because the pulses do not interfere at the receiver. In other words, the relative optical phase between isolated pulses at the receiver can be arbitrary. This means that the relative optical phase between inversely dispersed pulses at the transmitter can be arbitrary. Therefore, the resulting inversely dispersed waveform at the transmitter output does not need to be unique for the same received power waveform. The inversely dispersed waveform varies depending on the relative optical phase between two light paths, but all inversely dispersed waveforms result in the same receiving power waveform.

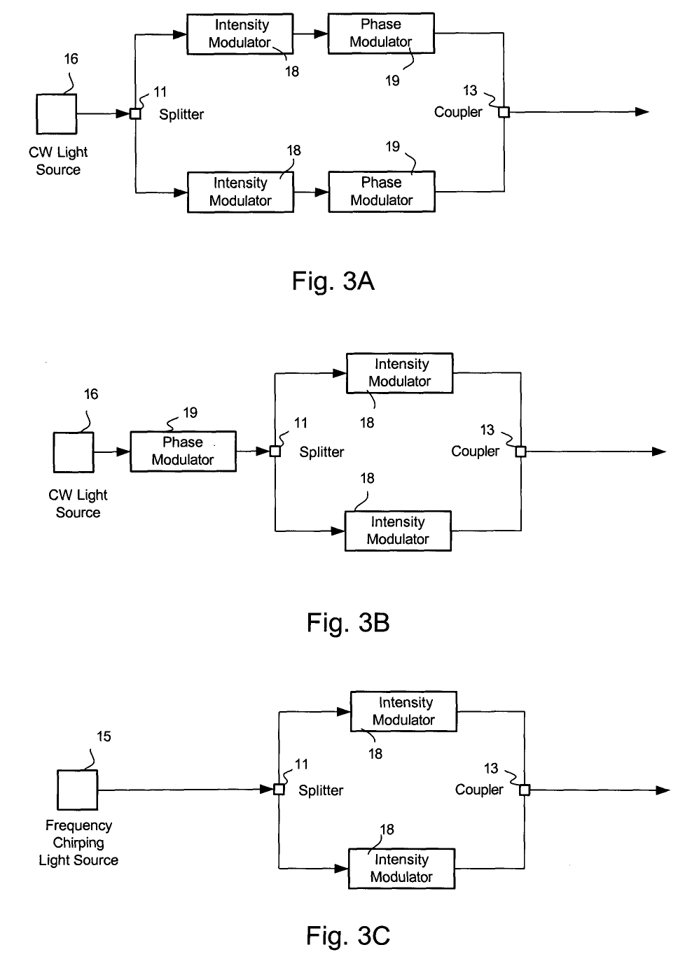

The design of optical pulse generators in multiple light paths can be created in many ways, according to the present invention. In FIG. 3A optical transmitter, the modulators 12 used in FIG. 2 are each formed by an intensity modulator 18 and a phase modulator 19 connected in series. The intensity modulator 18 shapes the CW light from CW light source 16 into a stretched pulse and the phase modulator 19 imparts a parabolic phase to the pulse to produce a pulse which is inversely dispersed. These modulators are modulated at half the bit rate. It is apparent that the phase modulator can be placed before the intensity modulator in each light path.

In FIG. 3B optical transmitter, a phase modulator is shared by the two light paths. The phase of light from CW light source 16 is modulated by a single phase modulator 19, which is modulated at half the bit rate. The light is then split into two light paths by splitter 11 and the light in each light path is modulated by intensity modulators 18 to create the inversely dispersed pulses which are combined for the transmitter output. In this design, the two light paths have different path lengths and produce a relative delay of a time span of one bit so that the light that passed through phase modulator 19 at the same time arrive at the coupler 13 with a delay of a time span of one bit after traveling through the light paths. Since the relative time delay between two light paths is a time span of one bit and the period of the periodic phase modulation with phase modulator 19 is a time span of two bits, inversely dispersed pulses arrive at the coupler 13 alternately from the two light paths.

In FIG. 3C optical transmitter, the frequency of light is chirped in frequency chirping light source 15. A well known method to produce frequency chirping light is directly modulating a diode laser. Thus the frequency of light is modulated at half the bit rate and light with a parabolic phase is produced. This light is split by splitter 11 and then the light in each light path is shaped into a stretched pulse by the intensity modulator 18. In this design, too, the two light paths have different path lengths and produce a relative time delay of a time span of one bit so that the light that left frequency chirping light source 15 at the same time arrive at the coupler 13 with a delay of a time span of one bit after traveling through the light paths. Since the relative time delay between two light paths is a time span of one bit and the period of the periodic frequency modulation with frequency chirping light source 15 is a time span of two bits, inversely dispersed pulses arrive at the coupler 13 alternately from the two light paths. This design is suitable when the chromatic dispersion is large, since the maximum optical phase in the pulse duration can be made large.

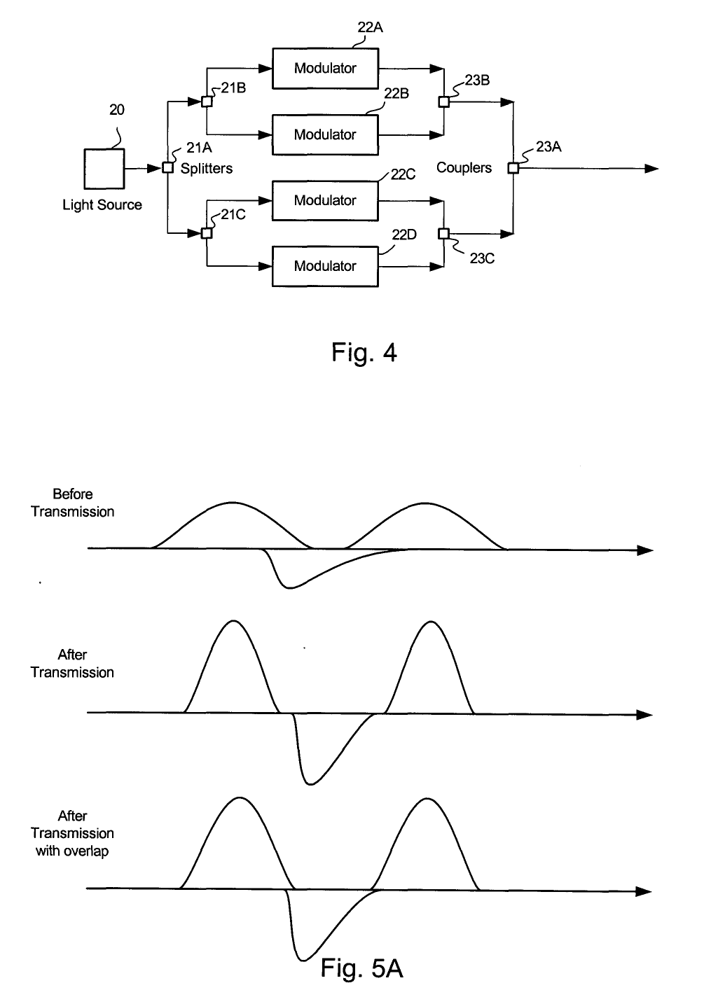

The optical transmitter of the present invention can easily be extended to more than two optical pulse generators, if the duration of the inversely dispersed pulse in each light path is longer than a time span of two bits. For example, FIG. 4 shows an optical transmitter with four optical pulse generators in parallel. In this example, light from a light source 20 is split by a splitter assembly, a first splitter 21A splitting the light into two light paths, and second splitters 21B or 21C which each further splits light from the first splitter 21 into two light paths. The outputs of the second splitter 21B form two parallel light paths with either modulator 22A or 22B. Likewise, the two outputs from the second splitter 21C form two more parallel light paths with either modulator 22C or 22D. Each modulator of 22A, 22B, 22C, and 22D is for example a combination of an intensity modulator and a phase modulator and the light source 20 is a CW light source. The outputs from the two modulators 22A and 22B are combined into one light path by a coupler 23B and the outputs from modulators 22C and 22D are combined into another light path by a coupler 23C. The output light paths from the couplers 23B and 23C are further combined by a coupler 23A and sent to the output of the transmitter. The modulators in the four parallel light paths between the splitter assembly formed by the assembly of splitters 21A-21C and the coupler assembly formed by the couplers 23A-23C allow a duration of an inversely dispersed pulse up to a time span of four bits in each light path. As described previously, in case of a transmitter having four light paths with a phase modulator or a frequency chirping light source, the relative time delays of the light paths compared to the shortest light path are time spans of one bit, two bits, and three bits for other light paths, respectively.

Thus using N parallel optical pulse generators, each optical pulse generator has a time span of N bits to produce an inversely dispersed pulse. The inversely dispersed pulse can have as long duration as a time span of N bits, and, in principle, there is no limit on the amount of chromatic dispersion. This waveform generation uses interference among the inversely dispersed pulses that overlap at the transmitter, and is not the conventional time division multiplexing.

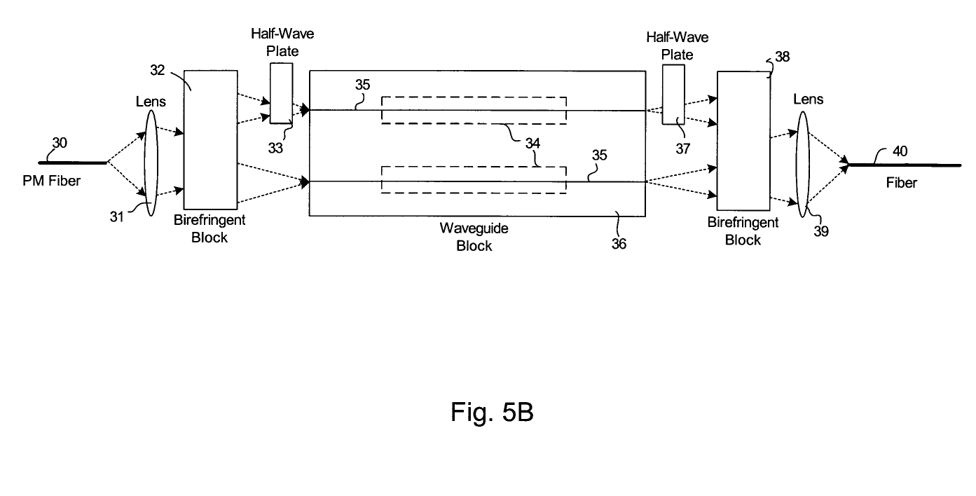

As described above, the pulses can theoretically be formed at the receiver with no overlap for an unlimited amount of chromatic dispersion. However, the contiguous pulses partially overlap at the receiver if the system is designed so that optical signals with NRZ (Non-Return to Zero) coding are to be detected at the receiver. In this case, to avoid the phase dependent interference between contiguous pulses at the receiver, orthogonal polarization light coupling is used to combine the light paths in the FIG. 2 transmitter in accordance with another embodiment of the present invention. There is no overlap with every other pulse in signals with NRZ coding. The waveforms using the orthogonal polarization light coupling are shown in FIG. 5A. The curves at the top represent the waveform at the transmitter. The curves in the middle represent the waveform at the receiver when the pulses do not overlap. The curves at the bottom represent the waveform at the receiver when the pulses do overlap. Contiguous pulses are orthogonally polarized at any distance along the transmission fiber, though each polarization does not necessarily need to be a linear polarization. The orthogonality of polarizations is maintained unless the light experiences a large polarization dependent loss. Thus, the signals do not suffer from the optical pattern effect between contiguous signals. Although two polarizations of light are used, polarization mode dispersion in the transmission fiber can be neglected as long as the bit rate is not too high and the transmission distance is not too long. Orthogonal polarization light coupling also helps avoid the 3 dB optical power loss, which is estimated for coupling with the same polarization light.

An exemplary optical waveguide transmitter which generates inversely dispersed pulses which are polarized orthogonally to each other as described above is shown in FIG. 5B. The optical transmitter has two parallel modulators as in the FIG. 2 arrangement. CW light from a laser source (not shown) is carried by a polarization-maintaining fiber 30 to be focused by a lens 31 through a birefringent block 32 into the waveguides 35. The block 32 separates the input light having the polarization axis at 45 degrees into two beams, one beam in one linearly polarized mode and the other beam orthogonally polarized to the first mode. The second beam passes through a half-wave plate 33 which rotates the plane of polarization by 90 degrees. Thus both beams have the same polarization. The two focused beams are then incident upon the respective ends of two waveguides 35 defined in a LiNbO₃ block 36. Each of the waveguides 35 has an electro-optic modulator region 37 for modulating the phase and intensity of the light in the waveguide 35 to form inversely dispersed pulses as described previously. The optical pulses formed in the waveguides 35 exit the block 36 and the polarization of one of the light beams is rotated by a second half-wave plate 38 so that the beam's polarization is orthogonal to that of the other beam. A second birefringent block 39 then combines the two beams into one beam which is focused by a second lens 40 into the end of an output fiber 41. The output fiber 41, which is connected to the transmission fiber, has inversely dispersed pulses of alternating orthogonal polarization as shown in the upper portion of FIG. 5A. The assembly between the polarization-maintaining fiber 30 and the waveguides 35 may be replaced by a polarization maintaining light splitter.

If the duration of an inversely dispersed pulse is longer than a time span of two bits and more than two optical pulse generators are used, the orthogonal polarization light coupling is used along with same polarization light coupling. Contiguous pulses are still orthogonally polarized. As an example of the FIG. 4 transmitter, the couplers 23B and 23C are same polarization couplers and the coupler 23A is an orthogonal polarization coupler. Since every other pulse has the same polarization and these pulses largely overlap at the transmitter, the inversely dispersed waveform is severely distorted and complicated. However, every other pulse does not overlap at the receiver even with NRZ coding. In this four optical pulse generator case, either, the optical phases from different light paths do not need to be locked and can arbitrary.

Empirical results were found to match theoretical expectations obtained by a numerical analysis. In the numerical analysis of the compression of an inversely dispersed pulse through chromatic dispersion, the magnitude of the inversely dispersed pulse with a duration of T was assumed to be cos(πt/T), and therefore, the intensity of the pulse was cos²(πt/T) in the time range, −T/2<t<T/2. The pulse had a parabolic phase of Ct², where C was adjusted to maximize the pulse compression effect.

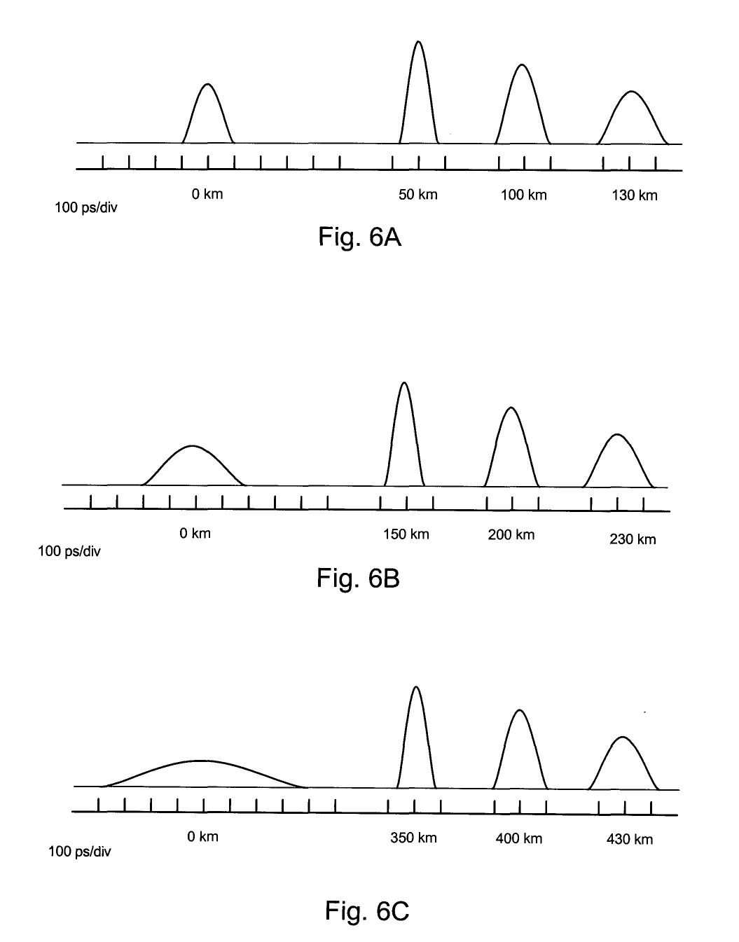

For a transmitter with two optical pulse generators at 10 Gbit/s modulation, the pulse duration T was assumed to be 200 ps, a time span of two bits. The change of the pulse shape along the fiber is shown in FIG. 6A, where C=2.5×10²⁰/sec². With this C value, the maximum phase within the pulse duration is 2.5 radians. Assuming a transmission fiber with chromatic dispersion of 1700 ps/nm, the pulse is compressed most at 50 km and the pulse duration at 100 km is still shorter than the initial duration. From these results, it is expected that 100 km transmission is achieved with little deterioration of signal quality. For a transmitter consisting of four optical pulse generators, targeting a longer transmission distance, the pulse duration T was assumed to be 400 ps, a time span of four bits. The pulse shapes along the fiber are shown in FIG. 6B, and in this case, C=1.1×10²⁰/sec². With this C value, the maximum phase within the pulse duration is 4.4 radians. The results show that the signal quality is high enough to achieve 200 km transmission. Finally, a transmitter with eight optical pulse generators were used with T=800 ps and C=0.6×10²⁰/sec². With this C value, the maximum phase within the pulse duration is 9.6 radians. As shown in FIG. 6C, the signals easily reach 400 km with little deterioration.

In these analyses for 100 km, 200 km, and 400 km distance transmissions, the duration of the pulse at the receiver is slightly longer than a time span of one bit. This does not cause a problem when the light is detected at the receiver as NRZ coded signals. It is noted that the pulse has almost no power at the center of the next bit, which is 100 ps away from the center of the pulse. This is the case when the signals at the receiver are ideal for NRZ coding. Since no phase dependent interference occurs between the contiguous pulses with orthogonal polarizations, the signal waveforms are not distorted and these transmission distances are achievable. Although the pulse for every other bit has the same polarization, phase dependent interference between these pulses is well suppressed, because no power is observed in that time range. More precisely, the maximum magnitude in that entire time range was calculated to be lower than 3.4%, corresponding to lower than 0.12% in power.

To verify the effectiveness of the transmitter design, a transmission experiment was carried out at 10 Gbit/s using a 100 km long standard single-mode fiber with a chromatic dispersion of 1700 ps/nm for light at a 1.55 μm wavelength. As can be seen in FIG. 6A, a time span of two bits is sufficient for an inversely dispersed pulse to receive signals with NRZ coding for this amount of dispersion. Therefore, a transmitter with of two LiNbO₃ intensity modulators with frequency chirping was used. The transmission light power was 3 dBm and an optical amplifier was placed in the middle of the fiber.

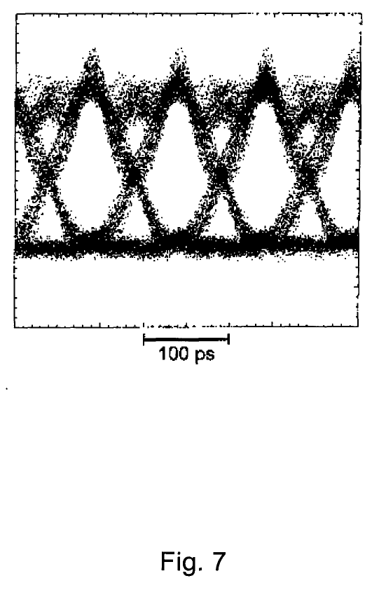

The resulting eye pattern after the transmission, i.e., at the receiver, is shown in FIG. 7. The eye openings are wide and clear, and the results show that the signals generated by the transmitter are received as high quality signals by a conventional receiver after transmission over 100 km of a standard single mode fiber. The waveform in the eye pattern is in good agreement with the predicted pulse shapes in the numerical analysis shown in FIG. 6A.

Therefore, while the description above provides a full and complete disclosure of the preferred embodiments of the present invention, various modifications, alternate constructions, and equivalents will be obvious to those with skill in the art. For example, the different designs of the optical pulse generators can be used in optical transmitters with N parallel modulators, N>2, and/or optical transmitters generating orthogonally polarized, inversely dispersed pulses. Thus, the scope of the present invention is limited solely by the metes and bounds of the appended claims.

What is claimed is:

1. An optical transmitter for generating optical signals in an optical fiber corresponding to electrical signals received at a first signal rate, said optical transmitter comprising
a plurality of optical pulse generators generating in parallel inversely dispersed optical pulses corresponding to said received electrical signals at said first signal rate;
a coupler assembly combining said generated inversely dispersed optical pulses for transmission in said optical fiber;
whereby said combination of said inversely dispersed optical pulses counter chromatic dispersion in said optical fiber so that optical pulses arrive at a receiver as non-dispersed optical pulses corresponding to said received electrical signals at said first signal rate.

2. The optical transmitter of claim 1 wherein each optical pulse generator is responsive to one of N subsets of said received electrical signals, each electrical signal of a subset separated by N−1 electrical signals of other subsets, each optical pulse generator generating a subset of inversely dispersed optical signal pulses at 1/N of said first signal rate;
and wherein said coupler assembly couples an output of each of said plurality of optical pulse generators to said optical fiber so that inversely dispersed optical pulses of each subset travel independently in the fiber.

3. The optical transmitter of claim 2 wherein each generated inversely dispersed optical pulse has a duration no more than a time span of N bits of said received electrical signals at said first signal rate.

4. The optical transmitter of claim 2 wherein each generated inversely dispersed optical pulse has an approximately parabolic phase.

5. The optical transmitter of claim 2 wherein each optical pulse generator generates said inversely dispersed optical pulses in a state of polarization and said coupler assembly combines said outputs of said optical pulse generators so that in said optical fiber an inversely dispersed optical pulse is orthogonally polarized to a contiguous inversely dispersed optical pulse.

6. The optical transmitter of claim 2 wherein N comprises two.

7. The optical transmitter of claim 2 wherein N comprises four.

8. The optical transmitter of claim 2 wherein N comprises eight.

9. The optical transmitter of claim 2 wherein said plurality of optical pulse generators comprises
a light source; and
a plurality of modulators, each modulator connected between said light source and said coupler assembly.

10. The optical transmitter of claim 9 wherein said light source comprises a CW light source, and each of said plurality of modulators is connected in parallel between said CW light source and said coupler assembly, and each modulator comprises an intensity modulator and a phase modulator connected in series.

11. The optical transmitter of claim 10 further comprising a splitter assembly connected between said CW light source and said plurality of modulators.

12. The optical transmitter of claim 9 wherein said light source comprises a CW light source, and said plurality of modulators comprise
a phase modulator connected to said CW light source; and
a plurality of intensity modulators connected in parallel between said phase modulator and said coupler assembly, where the light paths having said intensity modulators produce a relative time delay of plurality of the time span of one bit.

13. The optical transmitter of claim 12 further comprising a splitter assembly connected between said phase modulator and said plurality of intensity modulators.

14. The optical transmitter of claim 9 wherein said light source comprises a frequency chirping light source, and said plurality of optical pulse generators comprises a plurality of intensity modulators, each intensity modulator connected in parallel between said frequency chirping light source and said coupler assembly, where the light paths having said intensity modulators produce a relative time delay of plurality of the time span of one bit.

15. The optical transmitter of claim 14 further comprising a splitter assembly connected between said frequency chirping light source and said plurality of intensity modulators.

16. The optical transmitter of claim 2 wherein said plurality of optical pulse generators comprise at least two optical pulse generators and said coupler assembly comprises at least one optical coupler.

17. A method of operating an optical transmitter to generate optical signals in an optical fiber, said method comprising
receiving electrical signals at a first signal rate;
generating in parallel inversely dispersed optical pulses corresponding to said received electrical signals at said first signal rate;
combining said plurality of inversely dispersed optical pulses for transmission in said optical fiber;
whereby said combination of said inversely dispersed optical pulses counter chromatic dispersion in said optical fiber so that optical signal pulses arrive at a receiver as non-dispersed optical pulses corresponding to said received electrical signals at said first signal rate.

18. The method of claim 17 wherein said plurality of inversely dispersed optical pulses are generated as a plurality of N subsets of inversely dispersed optical pulses at a signal rate 1/N of said first signal rate, each subset corresponding to one of N subsets of said received electrical signals;
and wherein said N subsets of inversely dispersed optical pulses are combined so that inversely dispersed optical pulses of each subset travel independently in the fiber.

19. The method of claim 18 wherein each inversely dispersed optical pulse has a duration no more than a time span of N bits in received electrical signals at said first signal rate.

20. The method of claim 18 wherein each inversely dispersed optical pulse has an approximately parabolic phase.

21. The method of claim 18 wherein each subset of said inversely dispersed optical pulses has a state of polarization and wherein said subsets inversely dispersed optical pulses are combined so that in said optical fiber an inversely dispersed optical pulse is orthogonally polarized to a contiguous inversely dispersed optical pulse.

22. The method of claim 18 wherein N comprises two.

23. The method of claim 18 wherein N comprises four.

24. The method of claim 18 wherein N comprises eight.

25. An optical transmitter for generating optical signals in an optical fiber corresponding to electrical signals received at a first signal rate, said optical transmitter comprising
means for generating in parallel inversely dispersed optical pulses corresponding to said received electrical signals at said first signal rate;
means for combining said generated inversely dispersed optical pulses for transmission in said optical fiber;
whereby said combination of said inversely dispersed optical pulses counter chromatic dispersion in said optical fiber so that optical pulses arrive at a receiver as non-dispersed optical pulses corresponding to said received electrical signals at said first signal rate.

26. The optical transmitter of claim 25 wherein said optical pulse generating means comprise a plurality of optical pulse generators, each responsive to one of N subsets of said received electrical signals, each optical pulse generator generating a subset of inversely dispersed optical signal pulses at 1/N of said first signal rate;
and wherein said combining means couples an output of each of said plurality of optical pulse generators to said optical fiber so that inversely dispersed optical pulses of each subset travel independently in the fiber.

27. The optical transmitter of claim 26 wherein each generated inversely dispersed optical pulse has a duration no more than a time span of N bits in received electrical signals at said first signal rate.

28. The optical transmitter of claim 26 wherein each generated inversely dispersed optical pulse has an approximately parabolic phase.

29. The optical transmitter of claim 26 wherein each optical pulse generator generates said inversely dispersed optical pulses in a state of polarization and said combining means combines said outputs of said optical pulse generators so that in said optical fiber an inversely dispersed optical pulse is orthogonally polarized to a contiguous inversely dispersed optical pulse.
